(19) United States
(12) Patent Application Publication
(10) Pub. No.: US 2017/0011447 A1
(43) Pub. Date: Jan. 12, 2017

(54) Simplified Service Procurement

(71) Applicant: SAP SE, Walldorf (DE)

(72) Inventors: Johann Kemmer, Muhlhausen (DE); Paola Sala, Heidelberg (DE)

(73) Assignee: SAP SE, Walldorf (DE)

(21) Appl. No.: 14/794,293

(22) Filed: Jul. 8, 2015

(51) Int. Cl. G06Q 30/06

(52) U.S. Cl. CPC G06Q 30/0635

(57) ABSTRACT

A system, a method, and a computer program for simplified service procurement process are disclosed. A service order is generated and a plurality of service providers is selected from a list of available service providers for performance of the generated service order. The service order is provided to the selected service providers. An acceptance of performance of the service order is received from a service provider. The acceptance is based on exact terms contained in the service order. A cancellation of a request to perform the service order is forwarded to remaining service providers. Payment is provided to the service provider that accepted performance of the service order for performance of the service order.

### TECHNICAL FIELD

This disclosure relates generally to data processing and, in particular, to a simplified service procurement process.

### BACKGROUND

In today's world, many companies rely on software applications to conduct their business. Software applications deal with various aspects of companies' businesses, which can include service/product procurement, finances, product development, human resources, customer service, management, and many other aspects. Conventional systems for service procurement can be cumbersome and costly. Conventional systems typically perform the same procurement process for all types of service and/or products without differentiation among various business processes nor accounting for complexities associated with those processes, data to be exchanged between business partners, message choreography, usage of master data, etc. This leads to an increased cost of procurement processes, delays in procurement of products/services, ambiguities in contract negotiations relating to service/product procurement and/or other problems.

Thus, there is a need for a simplified procurement process that can reduce procurement costs, reduce the system overhead of companies seeking services/products, increase speed of the procurement process for both sides (i.e., an ordering company and service providers), and allowing for short-term (ad-hoc) planning to gain flexibility at the ordering company's side.

### SUMMARY

In some implementations, the current subject matter relates to a process for a simplified service procurement process. The method can include generating a service order and selecting a plurality of service providers from a list of available service providers for performance of the generated service order; providing the generated service order to the selected plurality of service providers; receiving an acceptance of performance of the generated service order from a service provider in the selected plurality of service providers, wherein acceptance is based on exact terms contained in the generated service order; forwarding cancellation of a request to perform the generated service order to remaining service providers in the plurality of service providers; and providing payment to the service provider that accepted performance of the service order for performance of the service order. At least one of the generating, the providing the generated service order, the receiving, the forwarding, and the providing payment can be performed by at least one processor of at least one computing system.

In some implementations, the current subject matter can include one or more of the following optional features. The generated service order can include at least one of the following: a description of at least one task, an offered price for performance of the at least one task, a time period within which to perform the at least one task, and a time period within which to accept performance of the service order.

The plurality of service providers can be selected based on a category of service orders to which the generated service order can belong.

In some implementations, forwarding of the cancellation to other service providers can be based on at least one of the following: a determination that the remaining service providers accepted performance of the generated service order after the receiving of the acceptance, a determination that the remaining service providers did not accept performance of the generated service, and/or a determination of a targeted order volume based on at least one confirmation received from at least one service provider.

In some implementations, the method can also include storing a status of the generated service order (i.e., providing it to the service order component) based on at least one of the following: receiving of the acceptance by a service provider, the task/time confirmation, forwarding of the cancellation of the service order to other service providers, and providing payment to the service provider that accepted the service order.

In some implementations, cancellation can be forwarded based on a determination that the remaining service providers did not accept performance of the generated service within a predetermined period of time specified by the generated service order.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an exemplary procurement process system, according to some implementations of the current subject matter;

FIG. 2 illustrates an exemplary process for procuring a service, according to some implementations of the current subject matter;

FIG. 3 illustrates an exemplary system, according to some implementations of the current subject matter; and

FIG. 4 illustrates an exemplary method, according to some implementations of the current subject matter.

### DETAILED DESCRIPTION

In some implementations, the current subject matter relates to an ability to provide a simplified procurement process that can be performed to a large extent automatically and/or manually. As part of the process, data relating to a product and/or service identified for the purposes of procurement can be evaluated. During the process, a service order component, an order confirmation component, a time confirmation component, a master data component, a payment component, and/or any other components can be involved. The components can be software, hardware, and/or any combination of software and hardware. The service order component can include and/or process task description, planned duration, offered price, latest confirmation date/time, etc. It can also provide an ability to attach documents to a service purchase order (e.g., word processing templates for reuse of service descriptions). The service order component can also provide integration into a master data component and allow creation of master data ad hoc based on the purchase order. It can further allow “over ordering”, i.e., allowing for a total order volume to be larger than required and finally admitted quantity of services. The service order component can accumulate confirmed and fulfilled quantity, cancel outstanding orders (e.g., automatically, after demand is fulfilled on order confirmations provided by other service providers), cancel an order (e.g., automatically, upon reaching latest confirmation date/time), transform service order item description into task description on a service provider side, transfer predefined attachment as service description (e.g., drawings, task description to potential service providers, etc.).

The order confirmation component can provide service confirmation as an “all or nothing” confirmation and/or any other type of confirmation. This component can also include a “first confirm first serve” functionality, which can provide an ability to get an order fulfilled by a first provider that satisfies terms of the order.

The time confirmation component can also provide an “all or nothing” confirmation ability in order to simplify confirmation process.

The master data component can include and/or store various data related to service providers, e.g., name(s), profile/skills (e.g., as related to a particular provider), general availability (e.g., “each Saturday evening” as related to any party to the order), account information (e.g., format of the account information can depend on providers, venues, countries, etc.), contact information, and/or any other information. The master data component can upload profile, skills, general availability, etc. to the purchaser or a party who is ordering services and can identify service providers for fulfillment of the order. These can be identified using links between service providers and/or service categories that may be stored in the master data (e.g., using “info records” in an enterprise resource planning (“ERP”) system). Using this information, the master data component can create business partner master data based on the order in ad hoc fashion.

In some implementations, the current subject matter can provide a simplified procurement process for service ordering, product ordering, and/or product and service ordering. Examples of products can include, but are not limited, to materials, tangible objects, services and materials, software, and/or any other types of products. The following description is presented in terms of service procurement process for ease of discussion and/or illustration; however, it can be applicable procurement of services, products, and/or both.

In some implementations, the current subject matter can provide a simplified procurement process that can differentiate between business process variants and specifically required complexity in terms of a degree of automation, data to be exchanged between business partners and/or systems, message choreography, usage of master data, etc. This is in contrast to the conventional systems where service procurement is substantially the same for all services to be procured. The current subject matter's procurement process can allow for significant reduction of internal and/or external process costs as well as gain in the desired flexibility and accelerates and simplifies the whole business process for those types of services.

In some implementations, the current subject matter's procurement process can provide a categorization of services that are purchased by a company and based on such categorization perform a special procurement process variant to procure services. One of the advantages of the current subject matter's procurement process is a simplification of a procurement process for commodity services using master data that is collected as a result of procurement. The process can reduce internal procurement costs, thereby reducing overhead of the ordering company, speeding up procurement process for the ordering company and its service providers, and allowing for short-term (or ad-hoc) planning, thereby gaining flexibility on the ordering company's side.

In some implementations, the procurement process can be established for particular service categories and/or can be setup for all categories of services that are being purchased by the company. At runtime of the procurement process, service information relating to service desired to be procured can be submitted. Upon receiving such information, at runtime, the current subject matter can determine service category based on the identified service. The category can be determined using information stored in a master data database, which can include a listing of categories of services (e.g., a hierarchical arrangement of categories, which can allow finding a specific category of services based on the identified service). Using the identified service category, a customizing table (containing information correlating services, categories, and services providers) can be accessed and as a result, a customized procurement process can be selected (e.g., manually, and/or automatically) for procurement of desired services. The customized procurement process can include a predetermined business process flow, screens, user interfaces, messages, etc.

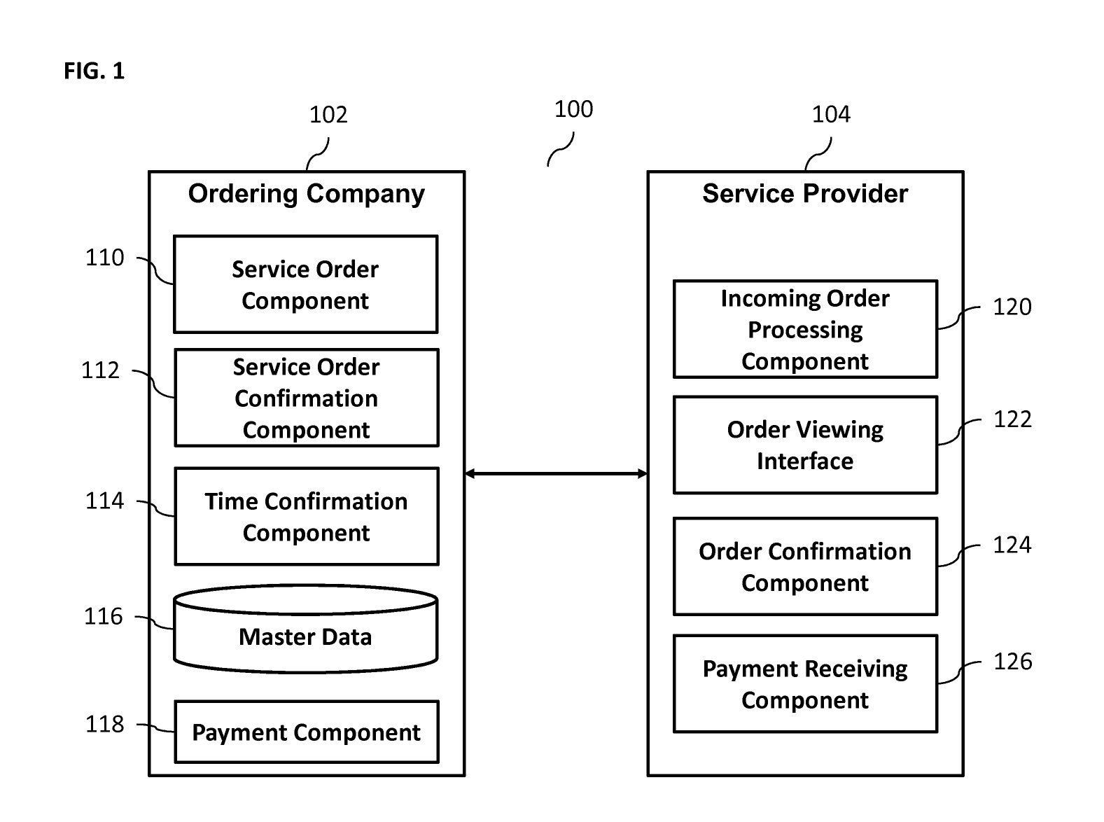

FIG. 1 illustrates an exemplary procurement process system 100, according to some implementations of the current subject matter. The system 100 can include an ordering company 102 communicatively coupled to one or more service provider systems 104. A single service provider system 104 is shown in FIG. 1, however, the ordering company 102 can be coupled to more than one service provider system. The ordering company 102 can include at least one processor and/or server communicatively coupled to at least one memory.

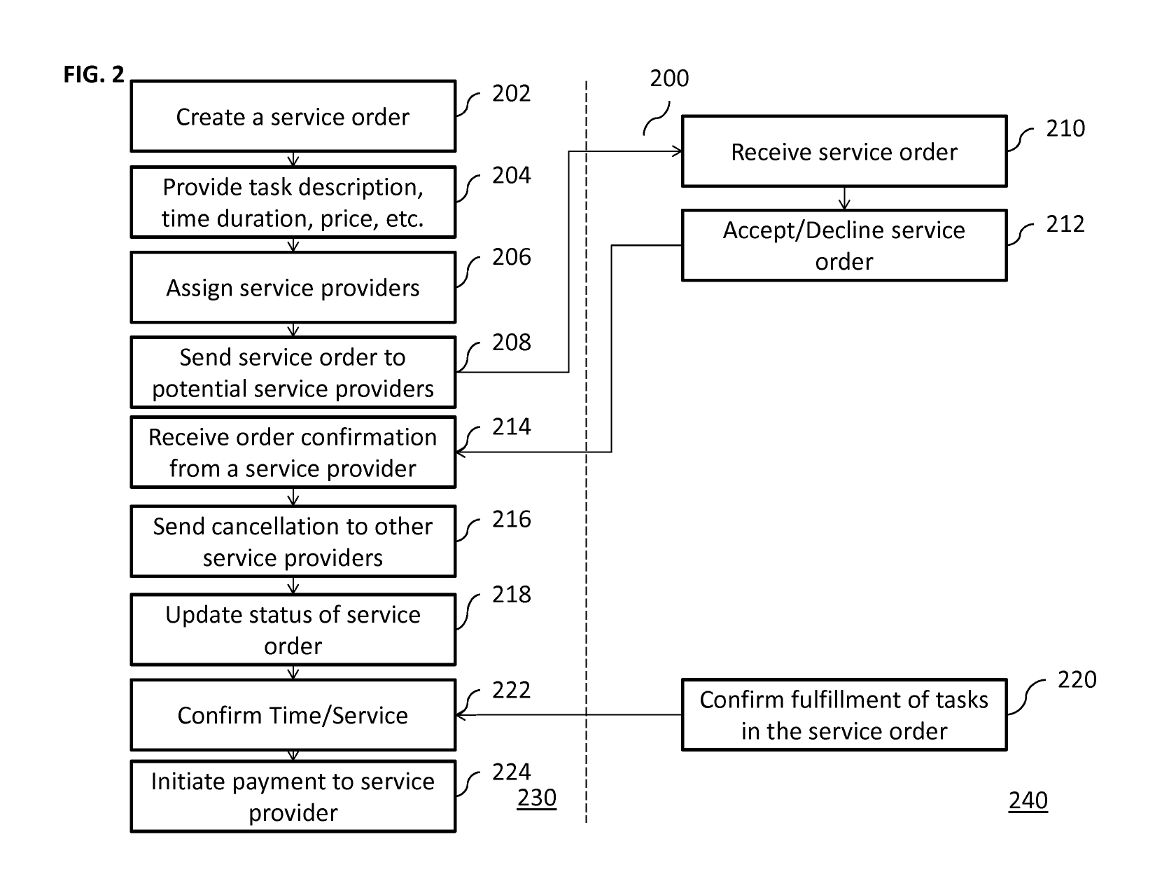

As part of the procurement process (as discussed below in connection with FIG. 2), the server can execute at least one of the following components: a service order component 110, a service order confirmation component 112, a time confirmation component 114, and a payment component 118. The components 110, 112, 114, 118 can be software, hardware, and/or any combination thereof and will have its own storage. As part of execution of the components 110, 112, 114, 118, the server can access a master data database 116. The components 110, 112, 114, 118 can also access the master data database 116 for data retrieval and/or storage (in case of ad-hoc creation of master data).

The service order component 110 can be used to initiate order procurement process. The service order component 110 can include one or more of the following information about the order: description of tasks that may be associated with the order, planned duration of the order, offered price (e.g., the price can be designated by the ordering company 102), and status (e.g., confirmations, payment, etc.). The service order component 110 can receive status indication from the service order confirmation component 112, the time confirmation component 114, and the payment component 118. The service order component 110 can communicate the details about the order to the service provider 104 and the service order component 110 can be accessed remotely by the service provider to view detail information about the order. The service order component 110 can also be updated by the payment component 118 as to whether a payment has been made by the ordering company 102 for a particular order.

The service order confirmation and time confirmation components 112, 114 can be used to confirm the order and time. These components can receive confirmation from the service provider 104 with regard to whether the service provider 104 confirmed and/or declined a particular order received from the service order component 110. These components can be a single component at the ordering company 102 and/or can be integrated with other components (e.g., component 110).

The master data database 116 can be accessed by the components 110, 112, 114, 118 for the purposes of retrieving data regarding a particular service provider and/or its categorization, such as to determine a particular service provider 104 that can potentially fulfill the order generated by the component 110. In some implementations, a single database can be provided below application layer (which is shown in FIG. 1) for use by all components. An example of such database can include a High Performance Analytic Appliance (“HANA”) in memory database, as developed by SAP SE, Walldorf, Germany. This single central database can accommodate storage of all instances of the above components in separate storages (where master data is being one of such storages). In some implementations, the database (whether a single central database or a separate database) can receive and store updates relating to the order that is being fulfilled (and/or declined) by selected server provider 104 (e.g., order particulars, timing of the order, service provider information, etc.). In some implementations, one or more separate storage locations can be provided for storage of data and/or information related to the service order itself, the service provider, service provider categorization, and/or any other information.

The service provider system 104 can include components that can interact with components 110, 112, 114, 118 during the service procurement process. In particular, the service provider system 104 can include an incoming order processing component 120, an order viewing user interface 122, an order confirmation component 124, and a payment receiving component 126. The incoming order processing component 120 can be used by the service provider 104 to process the order and view its parameters (e.g., service being sought, quantity, duration, price, etc.). Once the order has been processed, the service provider 104 can use the order viewing interface 122 to view further details of the order via A2X or Web Service call of service order in the ordering company system 102. Upon acceptance of the order, the service provider 104 can use order confirmation component 124 to confirm the order with the ordering company 102. The payment receiving component 126 can be used to receive payment from the ordering company 102 (such as using the payment component 118) for the service order as well as perform any requisite bookkeeping functions.

FIG. 2 illustrates an exemplary process 200 for procuring a service, according to some implementations of the current subject matter. The process 200 can be performed using the system 100 shown in FIG. 1 and/or any other system. Operations that can be performed at the ordering company are shown at 230 and operations that can be performed at the service provider are shown at 240.

At 202, a service order can be created or generated. The order can be generated by the ordering company 102 using its service order component 110. In some implementations, the order can be created automatically (based on service order requisitions) and/or manually. The service order can include a description of tasks to be performed, a duration and/or any other time limitation, an offered price, and/or any other parameters, at 204.

Once the service order is generated, the order can be provided to one or more potential service providers. The providers can be selected and/or assigned based on the specifics of the order automatically and/or manually, at 206. The order can be transmitted to the potential service providers using any communication channels (e.g., a business-to-business (“B2B” transmitted via a hypertext transfer protocol (“HTTP”)) message that can be tailored to the information contained in the order and/or communication preferences between the ordering company 102 and the service providers 104), at 208. The service order component can maintain various communication preferences for each specific provider. In some implementations, the providers can be selected from a list of preferred providers, which can be maintained by the ordering company 102 (e.g., its service order component 110). In alternate implementations, the providers can be selected at random.

In some implementations, the current subject matter can be provide for a simplified service procurement process where multiple service provider can be provide with different information as related to the same service order. For example, the current subject matter can allow defining a certain targeted order volume (per task/item) in the service order. However, a service order can be sent to different service providers containing different quantities. This can depend on service providers' specific capacities that can be maintained in master data records. When receiving order confirmations from various service performers, the current subject matter can add up confirmed quantities per task across service provider confirmations until the targeted quantity is reached, and then can send cancellations to the remaining service providers, which did not answer the service order request yet. For example, a service order generated by the ordering company can contain a volume quantity of 1000 units, which can be distributed to 10 service providers each having a capacity of 500 units, where each service provider can receive a service order for 500 units each. Once two service providers have confirmed the service order, the ordering company can forward cancellations to the remaining eight service providers. In alternate embodiments, the all ten service providers can receive the same service order for 1000 units, however, each service provider has a capacity of 500 units. Again, once two service providers accept an order and indicate that they are only able to provider 500 units each (due to their capacity), the remaining eight service providers will be sent cancellations.

Upon receipt of the services order by a service provider, at 210, the service provider can use its incoming order processing component 120 to process it. At the service provider 104, the transmitted service order can show up in a task list of the service provider's system and can include a task description, planned duration and/or any other time limitation, offered price, etc. The service provider 104 can also be provided with an option to accept or decline the service order, at 212.

In some implementations, the service provider 104 can use its order viewing interface 122 to view the details of the received order. If the service provider 104 invokes the view of the service order, a request can sent to the ordering company 102 asking to provide appropriate details of the order. This can be accomplished using any communication mechanisms (e.g., using A2X communication, etc.) The viewing interface 122 can provide the service provider with the ability to accept or decline the received service order (e.g., via use of buttons, etc.). If the service order is declined by the service provider 104, an appropriate notification can be provided to the ordering company 102. The service provider 104 can provide an “all or nothing” message to the ordering company 102, whereby the service provider 104 can accept all tasks in the received service order or decline all of them, i.e., no partial acceptance of the some tasks in the service order may be performed. The “all or nothing” acceptance of the order prevents any negotiation between the ordering company 102 and the service provider 104 or further changes to the service order (e.g., quantity, time, price, etc.) and can bind the parties to performance of the service order and subsequent payment for the services rendered in connection with the service order in accordance with the terms of the service order. Alternatively, the service provider can indicate that the service provider may perform some tasks in the service order while declining to perform others.

If the service provider 104 accepts the service order, a confirmation message (e.g., a B2B communication, etc.) can be sent to the ordering company, at 214. The message can include a service order identifier and an indication of whether or not it is accepted or declined. The confirmation message can be provided to the service order confirmation component 112 at the ordering company 102. Once the service order is accepted by one service provider 104, the ordering company 102 can forward cancellation of service order requests to other service providers 104 that have not accepted the service order and/or did not accept the service order prior to the first service provider that did, at 216. In some implementations, the service order can be accepted on a first-come first-served basis.

The service order confirmation component 112 can provide a status update to the service order component 110, at 218. The service order component 110 can also store all of the information related to the service order, its acceptance/declination, service providers that accepted/declined the order, and/or any other information in the database (which can be separate from the database 116).

In some implementations, the service provider 104 that accepted the order can also forward another confirmation message to the ordering company, at 220. The message can be transmitted using any communication channels (e.g., a B2B message) and can include a confirmation of tasks to be performed. This message can be received by the service order confirmation component 112 and/or time confirmation component 114 of the ordering company 102.

Once confirmations are received from the service provider 104, the confirmation components 112, 114 can provide an update of status of the service order to the service order component 110. Upon confirming the status of the service order, at 222, payment processing can be initiated by the ordering company, at 224. The payment to the service provider 104 can be rendered automatically and/or manually. The payment component 118 can be used to initiate payment. Depending on preferences that may exist at the ordering company and/or stored for a particular service provider 104, invoices can be settled automatically upon receipt, within a particular grace period, etc. The payment can be received by the payment receiving component 126 of the service provider 104 and/or can be deposited into the service provider's 104 bank account. Upon initiation of the payment to the service provider 104, the service order component 110 can be provided with an update indicative of the payment made.

In some implementations, the current subject matter's service order component 110 (or an easy service ordering system), as shown in FIG. 1, can be configured with at least one of the following information as pertaining to the service order. The component 110 can include task description, planned duration, offered price, latest confirmation date/time, etc. as related to the service order. The component 110 can also implement use of templates that can provide re-use of service descriptions for future service orders. The service order component can also be integrated with the master data database 116 to allow creation of master data (such as new service provider master data) on an ad hoc basis using the service order. As stated above, the service order component 110 can also send the service order to several service providers as well as perform “over ordering”, i.e., ordering a total order volume larger than what may be required by the ordering company 102 and/or finally requested quantity. The component can also accumulate confirmed and fulfilled quantity. In some implementations, the service order component 110 can send automatic cancellation of outstanding service orders to service providers after demand is fulfilled by order confirmations received from one or more service providers. Further, the service order can be automatically and/or manually cancelled by the service order component 110 if the order is not accepted by a specified date/time. The service order component 110, upon generating a service order containing various item descriptions, can cause transformation of the item description into task description at the service provider site. Along with the description, the service order component can attach various service description information (e.g., drawings, task description, etc.) for sending to the service provider.

In some implementations, the master data database 116 can store various information associated with service providers, etc. With regard to service providers, the database 116 can include service provider identification information, profile/skills, general availability (e.g., daily, “each Saturday evening”, etc.), service provider account information (e.g., special formatting preferred by the service provider in which to submit the service order, etc.), service provider contact information (e.g., address, telephone number, contact person, email, etc.). This information can be provided to the service order component 110 during generation of a service order. The database 116 can also store information about special classifications of service providers that may be participating on the simplified service procurement process discussed above. The information can also include identification of various service categories that contain service providers. This can allow automatic identification of possible service providers for sending service orders. The identification of service providers can be based on interlinkages between service providers and product categories persisted in the database 116. The database 116 can further allow ad hoc creation of business partner master data using a service order.

In some implementations, the current subject matter easy service ordering system has a plurality of advantages. It can allow the order company to reduce internal procurement costs and overhead by automation and streamlining the process, reduce internal procurement costs by avoiding overhead of complex business procedures (such as bidding and negotiation), speed up procurement process by reducing negotiation (which most probably is not intended for the targeted product categories), perform short-term and ad hoc planning, and gain flexibility with regards to the business partners addressed, as well as many other advantages.

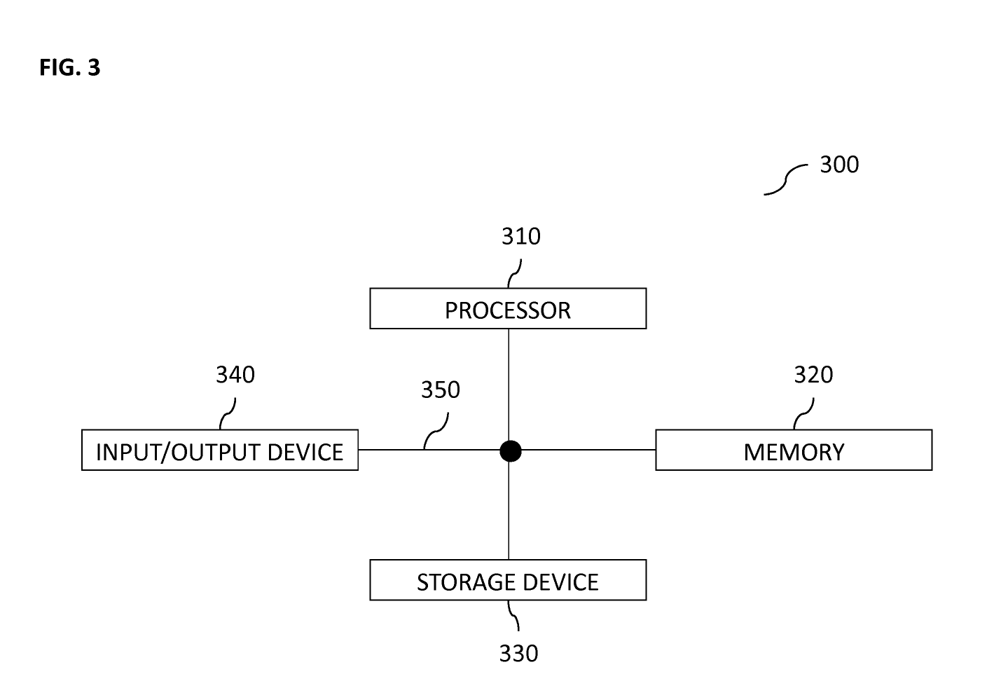

In some implementations, the current subject matter can be configured to be implemented in a system 300, as shown in FIG. 3. The system 300 can include a processor 310, a memory 320, a storage device 330, and an input/output device 340. Each of the components 310, 320, 330 and 340 can be interconnected using a system bus 350. The processor 310 can be configured to process instructions for execution within the system 300. In some implementations, the processor 310 can be a single-threaded processor. In alternate implementations, the processor 310 can be a multi-threaded processor. The processor 310 can be further configured to process instructions stored in the memory 320 or on the storage device 330, including receiving or sending information through the input/output device 340. The memory 320 can store information within the system 300. In some implementations, the memory 320 can be a computer-readable medium. In alternate implementations, the memory 320 can be a volatile memory unit. In yet some implementations, the memory 320 can be a non-volatile memory unit. The storage device 330 can be capable of providing mass storage for the system 300. In some implementations, the storage device 330 can be a computer-readable medium. In alternate implementations, the storage device 330 can be a floppy disk device, a hard disk device, an optical disk device, a tape device, non-volatile solid state memory, or any other type of storage device. The input/output device 340 can be configured to provide input/output operations for the system 300. In some implementations, the input/output device 340 can include a keyboard and/or pointing device. In alternate implementations, the input/output device 340 can include a display unit for displaying graphical user interfaces.

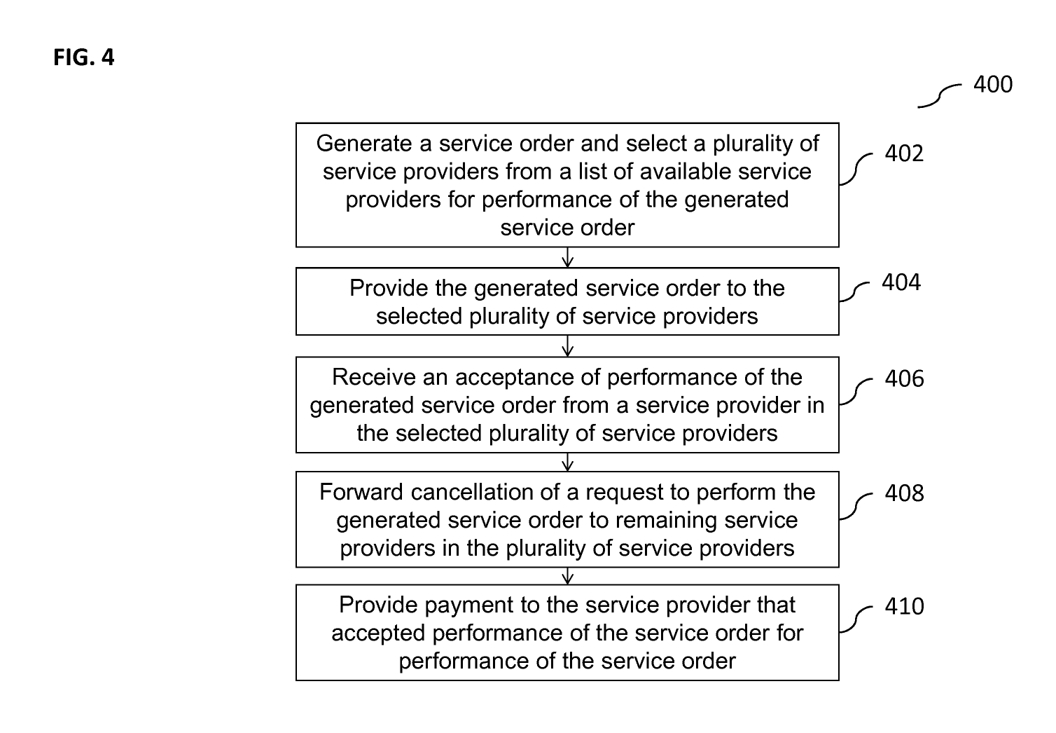

FIG. 4 illustrates an exemplary method 400 for performing a service procurement, according to some implementations of the current subject matter. At 402, a service order can be generated (e.g., by the service order component 110 shown in FIG. 1). Based on the generated service order, a plurality of service providers can be selected from a list of available service providers to perform the generated service order. At 404, the generated service order can be sent or provided to the selected plurality of service providers (e.g., providers 104 as shown in FIG. 1). At 406, an acceptance of performance of the generated service order can be received from a service provider in the selected plurality of service providers. The acceptance can be based on exact terms (i.e., “all or nothing”) contained in the generated service order. At 408, the ordering company can forward cancellation of a request to perform the generated service order to remaining service providers in the plurality of service providers (i.e., those that did not accept in time (i.e., on a first come first served basis), those that did not respond to the service order at all, etc.). At 410, payment to the service provider that accepted performance of the service order can be provided for performance of the service order.

In some implementations, the current subject matter can include one or more of the following optional features. The generated service order can include at least one of the following: a description of at least one task, an offered price for performance of the at least one task, a time period within which to perform the at least one task, and a time period within which to accept performance of the service order.

The plurality of service providers can be selected based on a category of service orders to which the generated service order can belong.

In some implementations, forwarding of the cancellation to other service providers can be based on at least one of the following: a determination that the remaining service providers accepted performance of the generated service order after the receiving of the acceptance, a determination that the remaining service providers did not accept performance of the generated service, and/or a determination of a targeted order volume based on at least one confirmation received from at least one service provider.

In some implementations, the method can also include storing a status of the generated service order (i.e., providing it to the service order component 110) based on at least one of the following: receiving of the acceptance by a service provider, the task/time confirmation, forwarding of the cancellation of the service order to other service providers, and providing payment to the service provider that accepted the service order.

In some implementations, cancellation can be forwarded based on a determination that the remaining service providers did not accept performance of the generated service within a predetermined period of time specified by the generated service order.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

1. A computer-implemented method, comprising:
generating a service order and selecting a plurality of service providers from a list of available service providers for performance of the generated service order;
providing the generated service order to the selected plurality of service providers;
receiving an acceptance of performance of the generated service order from a service provider in the selected plurality of service providers, wherein acceptance is based on exact terms contained in the generated service order;
forwarding cancellation of a request to perform the generated service order to remaining service providers in the plurality of service providers; and
providing payment to the service provider that accepted performance of the service order for performance of the service order;
wherein at least one of the generating, the providing the generated service order, the receiving, the forwarding, and the providing payment is performed by at least one processor of at least one computing system.

2. The method according to claim 1, wherein the generated service order includes at least one of the following: a description of at least one task, an offered price for performance of the at least one task, a time period within which to perform the at least one task, and a time period within which to accept performance of the service order.

3. The method according to claim 1, wherein the plurality of service providers is selected based on a category of service contained in the generated service order.

4. The method according to claim 1, wherein the forwarding further comprises forwarding cancellation of the request to perform the generated service order to the remaining service providers in the plurality of service providers based on at least one of the following:
a determination that the remaining service providers accepted performance of the generated service order after the receiving of the acceptance,
a determination that the remaining service providers did not accept performance of the generated service, and
a determination of a targeted order volume based on at least one confirmation received from at least one service provider.

5. The method according to claim 1, further comprising storing a status of the generated service order based on at least one of the following: the receiving of the acceptance, the forwarding of the cancellation, the task/time confirmation, and the providing the payment.

6. The method according to claim 1, wherein the cancellation is forwarded based on a determination that the remaining service providers did not accept performance of the generated service within a predetermined period of time specified by the generated service order.

7. A system comprising:
at least one programmable processor; and
a machine-readable medium storing instructions that, when executed by the at least one programmable processor, cause the at least one programmable processor to perform operations comprising:
generating a service order and selecting a plurality of service providers from a list of available service providers for performance of the generated service order;
providing the generated service order to the selected plurality of service providers;
receiving an acceptance of performance of the generated service order from a service provider in the selected plurality of service providers, wherein acceptance is based on exact terms contained in the generated service order;
forwarding cancellation of a request to perform the generated service order to remaining service providers in the plurality of service providers; and
providing payment to the service provider that accepted performance of the service order for performance of the service order.

8. The system according to claim 7, wherein the generated service order includes at least one of the following: a description of at least one task, an offered price for performance of the at least one task, a time period within which to perform the at least one task, and a time period within which to accept performance of the service order.

9. The system according to claim 7, wherein the plurality of service providers is selected based on a category of service contained in the generated service order.

10. The system according to claim 7, wherein the forwarding further comprises forwarding cancellation of the request to perform the generated service order to the remaining service providers in the plurality of service providers based on at least one of the following:
a determination that the remaining service providers accepted performance of the generated service order after the receiving of the acceptance,
a determination that the remaining service providers did not accept performance of the generated service, and
a determination of a targeted order volume based on at least one confirmation received from at least one service provider.

11. The system according to claim 7, wherein the operations further comprise storing a status of the generated service order based on at least one of the following: the receiving of the acceptance, the forwarding of the cancellation, the task/time confirmation, and the providing the payment.

12. The system according to claim 7, wherein the cancellation is forwarded based on a determination that the remaining service providers did not accept performance of the generated service within a predetermined period of time specified by the generated service order.

13. A comprising a machine-readable medium storing instructions that, when executed by at least one programmable processor, cause the at least one programmable processor to perform operations comprising:
generating a service order and selecting a plurality of service providers from a list of available service providers for performance of the generated service order;
providing the generated service order to the selected plurality of service providers;
receiving an acceptance of performance of the generated service order from a service provider in the selected plurality of service providers, wherein acceptance is based on exact terms contained in the generated service order;
forwarding cancellation of a request to perform the generated service order to remaining service providers in the plurality of service providers; and
providing payment to the service provider that accepted performance of the service order for performance of the service order.

14. The according to claim 13, wherein the generated service order includes at least one of the following: a description of at least one task, an offered price for performance of the at least one task, a time period within which to perform the at least one task, and a time period within which to accept performance of the service order.

15. The according to claim 13, wherein the plurality of service providers is selected based on a category of service contained in the generated service order.

16. The according to claim 13, wherein the forwarding further comprises forwarding cancellation of the request to perform the generated service order to the remaining service providers in the plurality of service providers based on at least one of the following:
a determination that the remaining service providers accepted performance of the generated service order after the receiving of the acceptance,
a determination that the remaining service providers did not accept performance of the generated service, and
a determination of a targeted order volume based on at least one confirmation received from at least one service provider.

17. The according to claim 13, wherein the operations further comprise storing a status of the generated service order based on at least one of the following: the receiving of the acceptance, the forwarding of the cancellation, the task/time confirmation, and the providing the payment.

18. The according to claim 13, wherein the cancellation is forwarded based on a determination that the remaining service providers did not accept performance of the generated service within a predetermined period of time specified by the generated service order.
